(19) United States
(12) Patent Application Publication
(10) Pub. No.: US 2020/0160280 A1
(43) Pub. Date: May 21, 2020

(54) SYSTEMS AND METHODS FOR OPTIMIZING MAINTENANCE PLANS

(71) Applicant: The Boeing Company, Chicago, IL (US)

(72) Inventors: Mohammad MOJTAHEDZADEH, Tulwila, WA (US); Karin Elaine BAUER, Tukwila, WA (US); Timothy GEHRET, Tukwila, WA (US); Jose M. GOMEZ-ELEGIDO, Renton, WA (US); Shervin BEYGI, Seattle, WA (US)

(21) Appl. No.: 16/198,471

(22) Filed: Nov. 21, 2018

(51) Int. Cl. G06Q 10/00; G06F 17/18; G06Q 10/06

(52) U.S. Cl. CPC G06Q 10/20; G06Q 10/063116; G06F 17/18

(57) ABSTRACT

Systems and methods for generating an optimized maintenance plan are provided. An approved maintenance plan for an apparatus type is received, which includes one or more intervals at which maintenance tasks are to be performed. One or more maintenance optimization objectives of an operator of an apparatus of the apparatus type is received as well as an operation history for the apparatus. A cost associated with the maintenance tasks and an end date to the optimized maintenance plan is determined and a statistical analysis on the approved maintenance plan, the one or more maintenance optimization objectives, the operation history of the apparatus, the end date, and the costs associated with the maintenance tasks is applied. Based on a result of the statistical analysis, the optimized maintenance plan, the generated optimized maintenance plan comprising an adjusted interval in the generated optimized maintenance plan is generated and presented.

### BACKGROUND

To ensure efficient operation of vehicles, operators follow a maintenance plan that is typically recommended by the manufacturer of the vehicle. Examples of such vehicles, include but are not limited to aircraft, air-cargo vehicles, automotive, unmanned aircraft vehicles (UAV), maritime vehicles (ships, submarines, etc.), etc. In the case of an aircraft, an MPD (maintenance planning data) is provided to the operator of an aircraft by the manufacturer and typically includes information about routine scheduled maintenance tasks, their intervals and required access, etc. The operator typically uses the MPD as a starting point and at times adjusts the schedule of its maintenance plan based on its financial and operational goals, for example. However, maintenance tasks often are grouped and performed in packages called “check packages”. The cost associated with each of the tasks, relevant information regarding the involved parts in each of the tasks, such as fleet wide performance and reliability data regarding one part, detailed design data, etc., are typically not available to the operator. Moreover, the operator often lacks advanced tools that enables customization of the maintenance plan (schedule and packages) based on their own fleet and/or vehicle data that is available to them. Examples of such data includes: —how many hours the vehicle was operated, —vehicle lease end date, etc., —how many defect findings they collected for each task. The lack of such relevant information and the advanced tools required to leverage it has consequential undesired effects on the operational effectivity and cost associated with the vehicle maintenance.

For example, operators, often follow a maintenance plan that is not efficient to their operation. In some cases, they would perform more maintenance tasks then needed, thus increasing the time of out of service for a vehicle. In other times, the available data to them seem to indicate that a maintenance package need to take place earlier than the time recommended. However, the operator, would not know the criticality or the possible consequences of not doing so, and takes on more risk than needed.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Some aspects and examples disclosed herein are directed to a method for generating an optimized maintenance plan (OMP). The method includes receiving an approved maintenance plan (AMP) for an apparatus type. A given apparatus type is a type or model of a particular apparatus. Therefore, if an apparatus is an aircraft, the apparatus type includes all aircraft of a particular model number, such as a Boeing 787. An apparatus type also includes all aircraft having one or more characteristics in common, such as, without limitation, all cargo aircraft, all aircraft that use the same engine model, or any other characteristic. Thus, an apparatus type includes the same or similar types of apparatus.

The AMP defines maintenance tasks for the apparatus type and defines intervals at which the maintenance tasks are to be performed. The method further includes receiving one or more maintenance optimization objectives of an operator of an apparatus of the apparatus type, and an operation history for the apparatus. A cost associated with the maintenance tasks and an end date to the OMP is determined, wherein the end date is based in part on a defined length of time to analyze the OMP, and this defined length of time is provided by the operator. Further, a statistical analysis on the AMP, the one or more maintenance optimization objectives, the operation history of the apparatus, the end date to the OMP, and the costs associated with the maintenance tasks is applied. Based on a result of the statistical analysis, the optimized maintenance plan is generated. The generated optimized maintenance plan including an adjusted one of the defined intervals.

### BRIEF DESCRIPTION OF THE DRAWINGS

The disclosed examples are described in detail below with reference to the accompanying drawing figures listed below:

FIG. 1 is a block diagram of apparatus production and service methodology.

FIG. 2 is a block diagram of an apparatus for various aspects of the disclosure.

FIG. 3 is a schematic perspective view of a particular flying module.

FIG. 4 is an exemplary block diagram of a memory area for a computing device.

FIG. 5 is a block diagram illustrating a process for an event analysis component 412 to determine a cost for each maintenance task and each maintenance package in an AMP 404 in the memory area 424 of the computing device 400.

FIG. 6 is a graph that illustrates an operation history of an apparatus or fleet of the apparatus.

FIG. 7 is a block diagram illustrating a process for the maintenance event analysis component 412 to generate an OMP.

FIG. 8 is a graph illustrating a repackaging of a plurality of maintenance tasks under the AMP 404 by the maintenance event analysis component 412.

FIG. 9 is a table illustrating an exemplary optimization of events by the maintenance event analysis component 412.

FIG. 10 is illustrates AMP and OMP graphs utilized by the maintenance event analysis component 412.

FIG. 11 is a flow chart illustrating an exemplary operation of the maintenance event analysis component 412 generating an optimized maintenance plan.

FIG. 12 is an exemplary block diagram illustrating a system suitable for implementing various aspects of the disclosure.

Corresponding reference characters indicate corresponding parts throughout the drawings.

### DETAILED DESCRIPTION

The various embodiments will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property can include additional elements not having that property.

Aspects of the present disclosure provide a computer implemented method, apparatus, and computer program product for optimizing maintenance packages. For example, for a particular apparatus (e.g., a type or model of a particular apparatus or fleet of apparatus), historic maintenance data, which includes costs that have been incurred for each maintenance event under an approved maintenance plan (AMP), for example, a maintenance plan that is currently implemented for the apparatus type, is accessed. From the historic maintenance data and the current maintenance plan, maintenance events, which comprise one or more maintenance packages are analyzed to determine a cost associated with each maintenance event. A maintenance event is any event that is associated with maintenance, repair, or replacement of a component of an apparatus. In one embodiment, a maintenance event includes, for example, a functional part failure, a system failure, loss of function, decreased function, service interrupt, corrosion, wear, slow response time, decreased efficiency, decreased fuel efficiency, loss of tire pressure, or any other event that necessitates maintenance, repair, or replacement of a component or subpart of a component. Further, each maintenance event includes one or more maintenance packages, and each maintenance package includes one more maintenance tasks. As used herein, a maintenance task is a task associated with inspecting, maintaining, repairing, and/or replacing a component or subcomponent.

By accessing a cost incurred for each maintenance event (which can be accessed from the historic maintenance data) and identifying each maintenance package included in each maintenance event, the cost of each maintenance task can be determined. Using the determined costs, one or more maintenance optimization objectives (e.g., provided by an operator of the apparatus or fleet of the apparatus), available resources (e.g., workers and facility availability at any given time), and a defined length of time for a total operational life cycle of an apparatus (e.g., a defined length of time an operator owns the apparatus or fleet of the apparatus), each of the plurality of maintenance tasks are repackaged into optimized maintenance packages, which re-groups the plurality of maintenance tasks to reduce costs and/or satisfy one or more of the maintenance optimization objectives. In addition, an optimized maintenance plan (OMP) is provided in which each of the optimized maintenance packages are assigned to a particular event, with each event indicating a time/interval the optimized maintenance packages assigned thereto are scheduled to be executed. However, in order to begin the OMP, aspects of the present disclosure also determine which event in the current maintenance plan is the last event to be executed under the current maintenance plan, and which event in the OMP is the first event to be executed under the OMP in order to seamlessly transition from the current maintenance plan to the optimization maintenance plan. Aspects of the present disclosure also enable an operator of the apparatus or fleet of the apparatus to adjusts information, such the one or more maintenance optimization objectives, the available resources, and the defined length of time for the total operational life cycle of an apparatus. By adjusting the information, the operator has the ability to identify the impact of each adjustment and thus further optimize the OMP accordingly.

By repackaging the maintenance tasks into optimized maintenance packages, assigning the optimized maintenance packages to events in the OMP, and determining when to transition from the current maintenance plan to the OMP, aspects of the present disclosure minimize the frequency of planned maintenance events and improves apparatus dispatch with optimized scheduling of preventative planned maintenance tasks while minimizing an occurrence of un-planned in-service maintenance tasks. For example, by increasing an interval for a maintenance task (e.g., the number of days between performing the maintenance task), that particular maintenance task is performed on the apparatus or fleet of the apparatus a decreased number of times for the total operational life cycle the operator owns the apparatus or fleet of the apparatus (e.g., based on a lease agreement). That is, increasing an interval can be thought of as postponing maintenance on that particular maintenance task. By postponing maintenance for the particular maintenance task, the costs associated with performing the particular maintenance is also postponed. In one embodiment, postponing costs for the particular maintenance task (e.g., deferring costs from a current calendar year to the next calendar year) has a positive impact on an operator for example, if the operator is facing budget restrictions for the current calendar year. Furthermore, with a leased apparatus or fleet of the apparatus, the increased interval could result in the particular maintenance being postponed beyond the apparatus's lease return date. As such, the apparatus company would not incur the cost of the particular maintenance given the apparatus would be returned prior to the particular maintenance being performed.

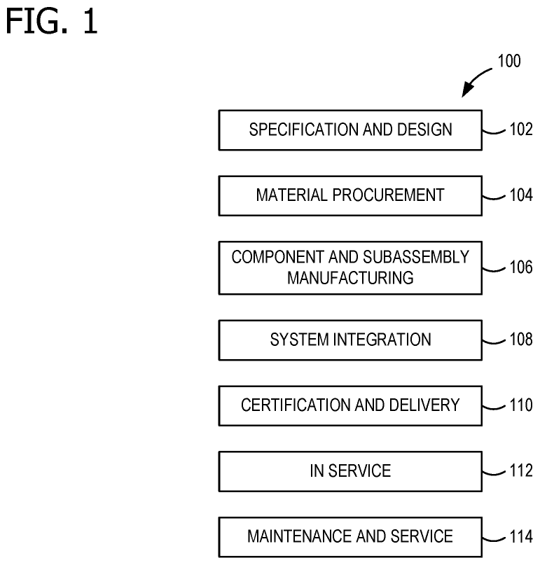

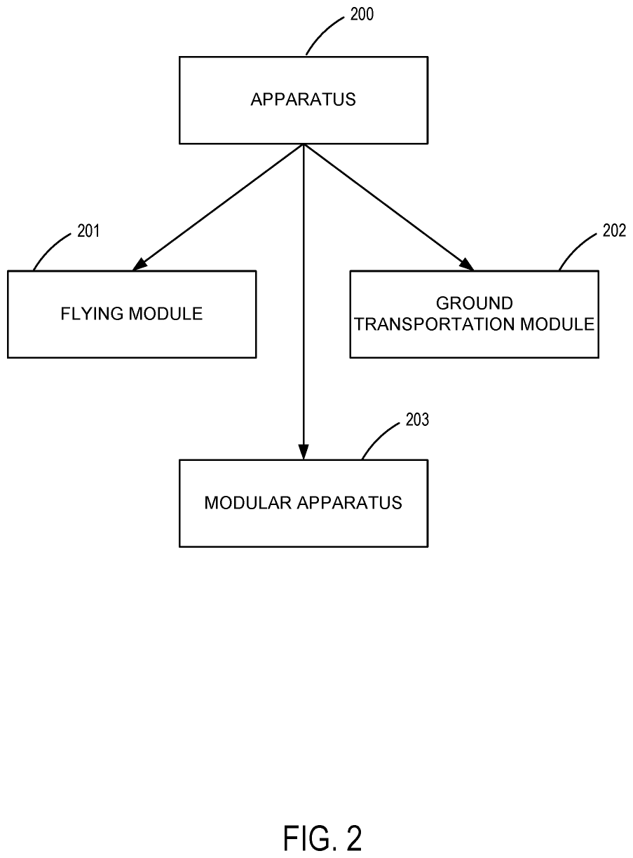

Referring more particularly to the drawings, embodiments of the disclosure can be described in the context of an apparatus of manufacturing and service method 100 as shown in FIG. 1 and apparatus 200 provided in FIG. 2.

Turning first to FIG. 1, a diagram illustrating an apparatus (e.g., the carrying module 200) manufacturing and service method is depicted in accordance with an embodiment. In one embodiment, during pre-production, the apparatus manufacturing and service method 100 includes specification and design 102 of the apparatus 200 in FIG. 2 and material procurement 104. During production, component and subassembly manufacturing 106 and system integration 108 of the apparatus 200 in FIG. 2 takes place. Thereafter, the apparatus 200 in FIG. 2 goes through certification and delivery 110 in order to be placed in service 112. While in service by a customer, the apparatus 200 in FIG. 2 is scheduled for routine maintenance and service 114, which, in one embodiment, includes modification, reconfiguration, refurbishment, and other maintenance or service described herein.

In one embodiment, each of the processes of the apparatus manufacturing and service method 100 are performed or carried out by a system integrator, a third party, and/or an operator. In these examples, the operator is a customer. For the purposes of this description, a system integrator includes any number of apparatus manufacturers and major-system subcontractors; a third party includes any number of venders, subcontractors, and suppliers; and in one embodiment, an operator is an owner of an apparatus or fleet of the apparatus, an administrator responsible for the apparatus or fleet of the apparatus, a user operating the apparatus, a leasing company, a military entity, a service organization, or the like.

With reference now to FIG. 2, the apparatus 200 is provided. As shown in FIG. 2, an example of the apparatus 200 is a flying apparatus 201, such as an aerospace vehicle, aircraft, air cargo, flying car, and the like. As also shown in FIG. 2, a further example of the apparatus 200 is a ground transportation apparatus 202, such as an automobile, a truck, heavy equipment, construction equipment, a boat, a ship, a submarine and the like. A further example of the apparatus 200 shown in FIG. 2 is a modular apparatus 203 that comprises at least one or more of the following modules: an Air module, a payload module and a ground module. The air module provides air lift or flying capability. The payload module provides capability of transporting objects such as cargo or live objects (people, animals, etc.). The ground module provides the capability of ground mobility. The disclosed solution herein is applied to each of the modules separately or in groups such as air and payload modules, or payload and ground, etc. or all modules.

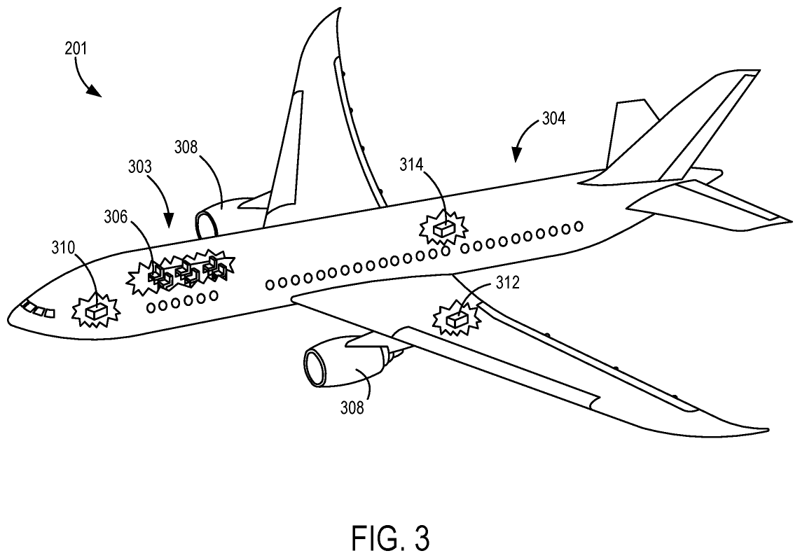

With reference now to FIG. 3, a more specific diagram of the flying module 201 is depicted in which an embodiment is implemented. In this example, the flying module 201 is an aircraft produced by the apparatus manufacturing and service method 100 in FIG. 1 and includes an airframe 303 with a plurality of systems 304 and an interior 306. Examples of the plurality of systems 304 include one or more of a propulsion system 308, an electrical system 310, a hydraulic system 312, and an environmental system 314. However, any number of other systems can be included. Although an aerospace example is shown, different advantageous embodiments are applied to other industries, such as the automotive industry, etc.

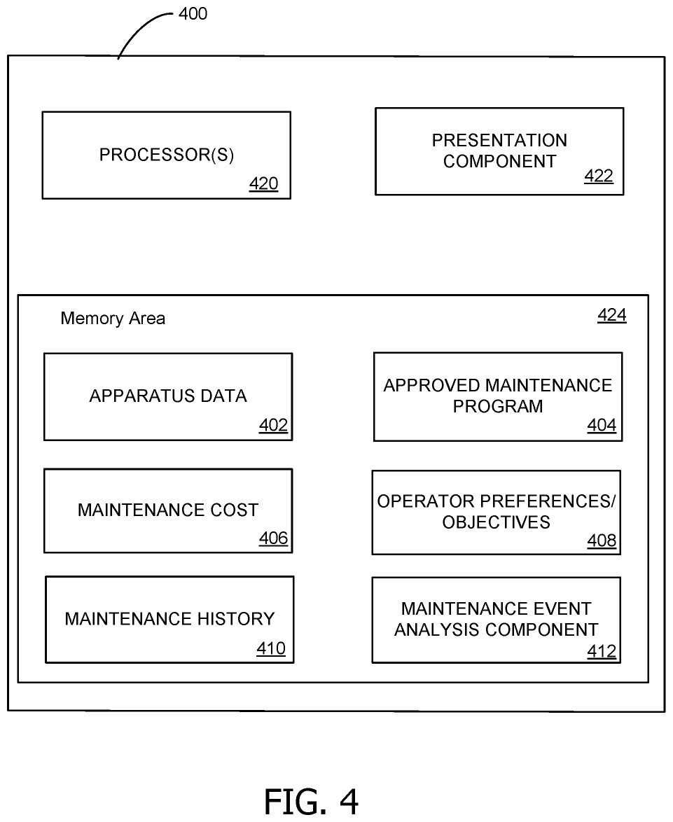

With reference now to FIG. 4, a block diagram of a computing device 400 for generating an OMP is provided. The computing device 400 includes one or more processors 420, one or more presentation components 422 and a memory area 424. The disclosed examples associated with the computing device 400 can be practiced by a variety of computing devices, including personal computers, laptops, smart phones, mobile tablets, hand-held devices, consumer electronics, specialty computing devices, etc. The disclosed examples are also practiced in distributed computing environments, where tasks are performed by remote-processing devices that are linked through a communications network, for example, via distributed computing environment hosts cloud synthetics services. Further, while the computing device 400 is depicted as a seemingly single device, in one embodiment, multiple computing devices work together and share the depicted device resources. For instance, in one embodiment, the memory area 424 is distributed across multiple devices, the processor(s) 420 provided are housed on different devices, and so on.

In one embodiment, the processor(s) 420 includes any quantity of processing units that read data from various entities, such as the memory area 424. Specifically, the processor(s) 420 are programmed to execute computer-executable instructions for implementing aspects of the disclosure. In one embodiment, the instructions are performed by the processor, by multiple processors within the computing device 400, or by a processor external to the computing device 400. In some examples, the processor(s) 420 are programmed to execute instructions such as those illustrated in the flowcharts discussed below and depicted in the accompanying drawings. Moreover, in some examples, the processor(s) 420 represent an implementation of analog techniques to perform the operations described herein. For example, the operations are performed by an analog client computing device 400 and/or a digital client computing device 400.

The presentation component(s) 422 present data indications to an operator (e.g., owner of the apparatus or fleet of the apparatus, administrator responsible for the apparatus or fleet of the apparatus, or a user operating the apparatus) or to another device. Exemplary presentation components include a display device, speaker, printing component, vibrating component, etc. One skilled in the art will understand and appreciate that computer data is presented in a number of ways, such as visually in a graphical user interface (GUI), audibly through speakers, wirelessly between the computing device 400, across a wired connection, or in other ways.

The memory area 424 stores apparatus data 402, an AMP 404, maintenance costs 406, operator preferences/objectives 408, maintenance history 410, and maintenance event analysis component 412. The apparatus data 402 includes an apparatus delivery date, an apparatus retirement date, and operating hours for a particular type of apparatus or fleet of apparatus, and if leased, an apparatus's lease return date, clearance period, and lease terms (e.g., what maintenance event must be performed before returning the apparatus to the lessor).

In one embodiment, the AMP 404 includes one or more of the following: maintenance tasks recommended in maintenance planning data, apparatus specific maintenance tasks, an inspection event for the apparatus, labor hours spent, and access requirements during maintenance. The maintenance costs 406 include historic costs incurred by an operator, (e.g., owner of the apparatus or fleet of the apparatus, administrator responsible for the apparatus or fleet of the apparatus, or a user operating the apparatus) for a plurality of maintenance tasks for an apparatus or fleet of the apparatus. And more specifically, the historic cost of each event stored in the maintenance costs 406 are based on known costs incurred from one or more maintenance providers (e.g., a company that performed the task associated with the maintenance tasks that is provided in the maintenance costs 406), based on apparatus labor, materials, and the like. The maintenance history 410 includes information describing historic maintenance events that have been performed from the AMP 404.

The maintenance event analysis component 412 is a software statistical analysis tool that identifies an optimal event requirement for planning maintenance on an apparatus or fleet of apparatus. In one embodiment, the statistical analysis is implemented using known or available statistical application program, such as, but without limitation, statistical analysis software (SAS).

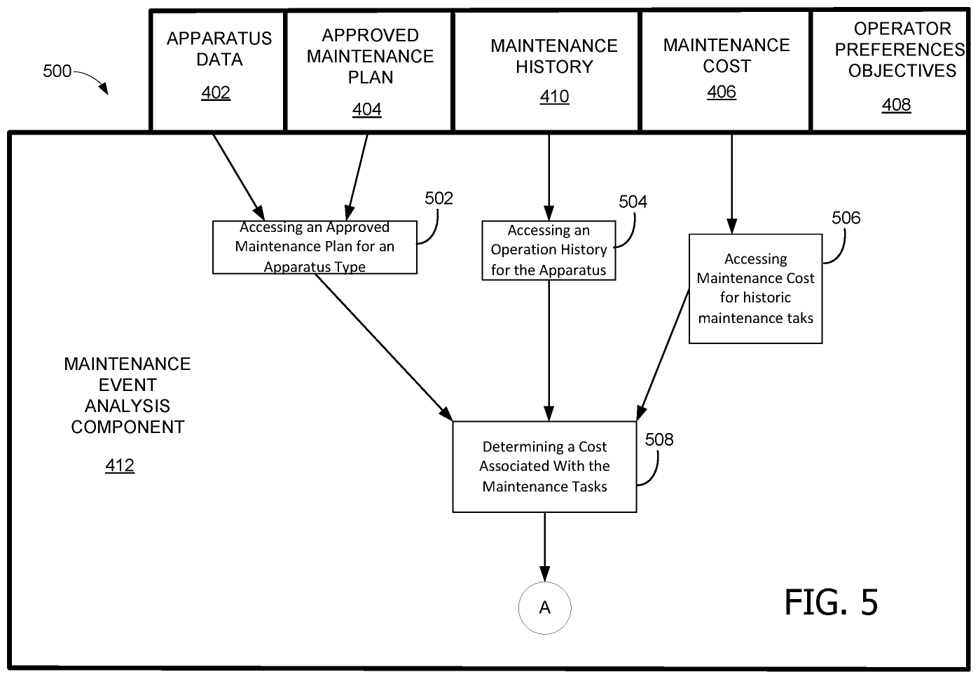

For example, with reference now to FIG. 5, a block diagram illustrating a process 500 for the event analysis component 412 to determine a cost for each maintenance task and each maintenance package in the AMP 404 is provided.

At 502, for a particular apparatus (e.g., a type or model of a particular apparatus) identified in the apparatus data 402, the maintenance event analysis component 412 accesses a maintenance plan that is currently implemented for the apparatus type from the AMP 404. At 504, an operation history is accessed from the maintenance history 410. The operation history includes historic maintenance data that provides costs that have been incurred for each maintenance event under the AMP for the particular apparatus or fleet of the particular apparatus.

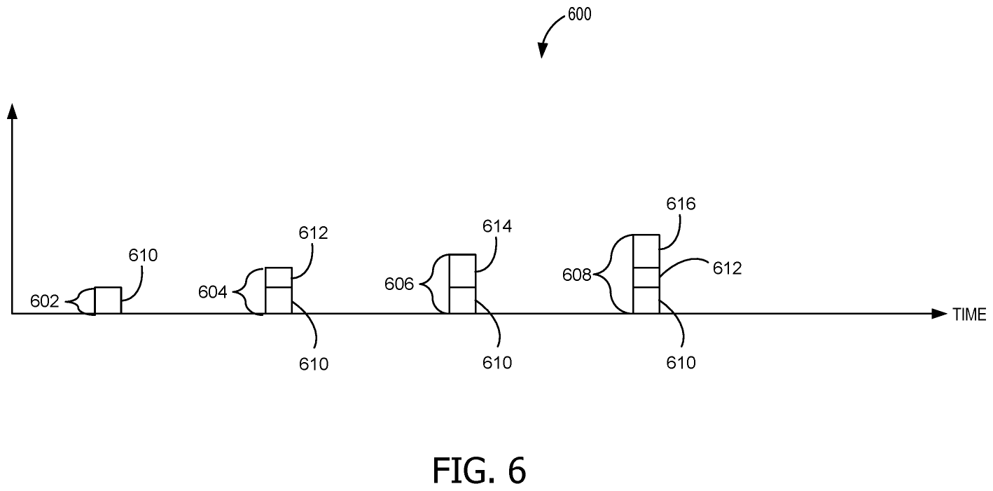

For example, with reference now to FIG. 6, a graph 600 is provided that illustrates an operation history of an apparatus or fleet of the apparatus. The operation history includes a plurality of maintenance events, 602, 604, 606, and 608. Each of the maintenance events includes one or more maintenance packages. For example, the maintenance event 602 includes maintenance package 610, the maintenance event 604 includes maintenance packages 610 and 612, the maintenance event 606 includes maintenance packages 610 and 614, and the maintenance event 608 includes maintenance packages 610, 612, and 616. As shown in FIG. 6, a total cost of each maintenance event is all that is provided in the operation history. That is, while the maintenance events 604, 606, and 608 include multiple maintenance packages in each event, only a total cost of the sum of all of the packages in each maintenance event is known. The operation history does not provide a breakdown of the cost for each maintenance package separately. However, in the example shown in FIG. 6, to generate an OMP, the maintenance event analysis component 412 not only determines the cost of each of the maintenance packages 610-616, but also the cost of each maintenance task within each of the maintenance packages 610-616.

With reference back to FIG. 5, at 506, the maintenance event analysis component 412 accesses the maintenance costs for historic maintenance events from the maintenance cost 406. That is, because the historic cost of each maintenance event stored in the maintenance costs 406 are based on known costs incurred from one or more maintenance providers (e.g., a company that performed the task associated with the maintenance tasks that is provided in the maintenance costs 406), the maintenance event analysis component 412 can determine a cost associated with each maintenance package in a maintenance event, and each maintenance task within each maintenance package from the operation history accessed from the maintenance history 410. That is, as indicated in FIG. 6, the operation history 600 identifies the maintenance packages that makeup each maintenance event. Thus, the maintenance event analysis component 412 identifies corresponding costs of each maintenance package. Further, from the maintenance costs 406, the maintenance event analysis component 412 also identifies the cost associated with each maintenance task that is included in the corresponding maintenance packages. Therefore, with the understanding of how much each maintenance task in corresponding maintenance packages cost (e.g., from the maintenance cost 406), the maintenance event analysis component 412 can estimate the cost for each maintenance task and thus a cost for each maintenance package identified in the operation history. Furthermore, by understanding the costs associated with the maintenance packages/tasks from the maintenance history 410, these costs can be applied to the maintenance tasks and maintenance packages in the AMP 404.

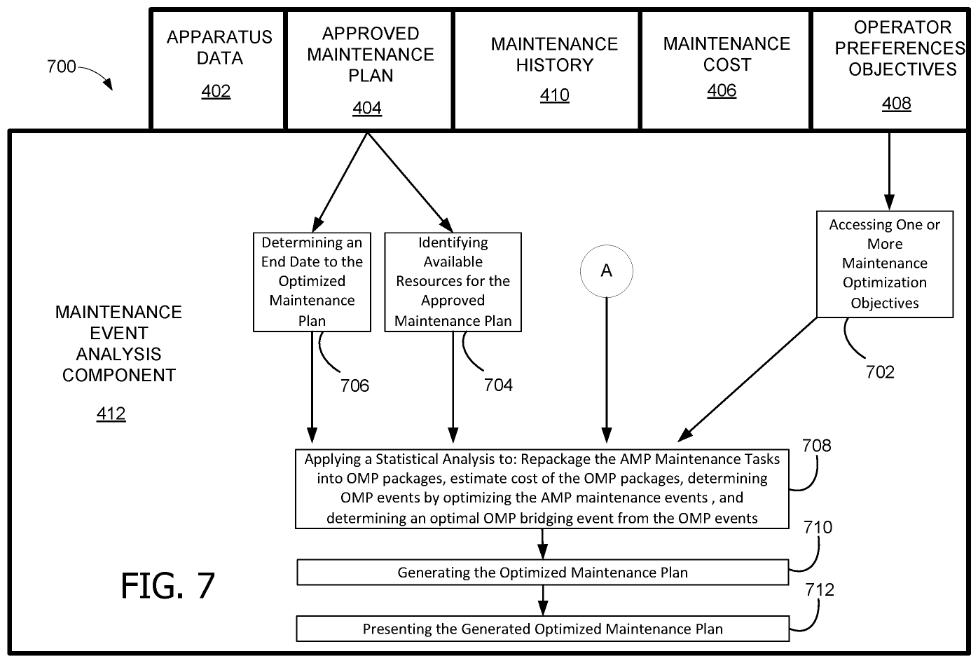

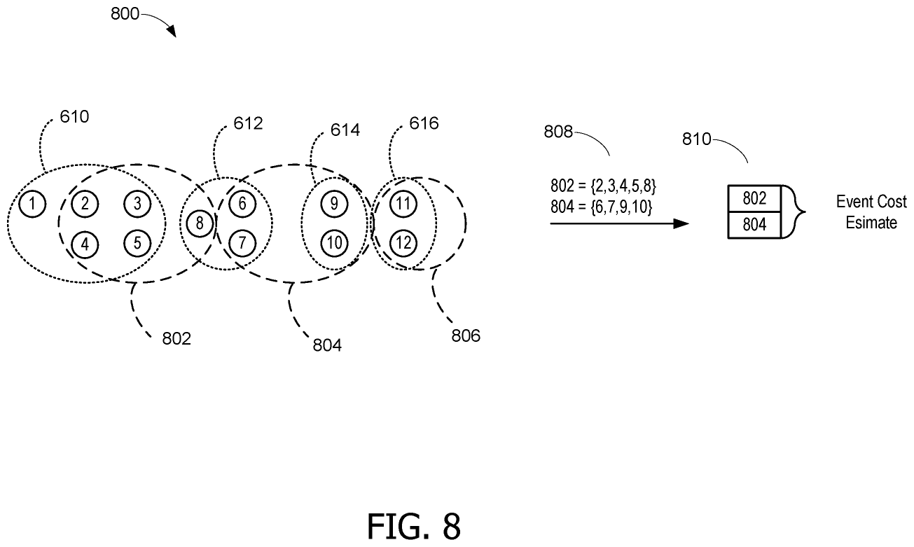

With reference now to FIG. 7, a block diagram illustrating a process 700 for the event analysis component 412 generating an OMP is provided. At 702, one or more maintenance optimization objectives (e.g., provided by an operator of the apparatus or fleet of the apparatus) is accessed by the maintenance event analysis component 412. At 704, the maintenance event analysis component 412 identifies the available resources (e.g., workers and facility availability at any given time) in the AMP 404. At 706, the maintenance event analysis component 412 identifies a defined length of time for a total operational life cycle of the apparatus from the AMP 404. At 708, the maintenance event analysis component 412 applies a statistical analysis on the AMP 404. Using the statistical analysis, each of the plurality of maintenance tasks under the AMP 404 are repackaged into optimized maintenance packages, OMP events are determined by optimizing the AMP maintenance events, and an optimal OMP bridging event (the first event to be executed under the OMP and that is not executed under the AMP) is determined from the OMP events. Details about the tasks repackaging are discussed further below with reference to FIG. 8.

At 710, based on a result of the statistical analysis, the OMP is generated. The generated OMP comprises the OMP packages assigned to particular OMP events, a bridging event and bridging event date for the seamless transition between the AMP event and the OMP events.

At 712, in one embodiment, the generated OMP is presented to an operator. In another embodiment, the generated OMP is automatically applied by replacing the AMP 404, and enabling a seamless transition between the AMP 404 and the OMP without user intervention. The generated OMP provides a particular date the optimal OMP bridging event is scheduled, as well dates for the one or more additional OMP events. Whether the generated OMP is presented to the operator or automatically implemented, in a further embodiment, the operator compares the generated OMP with the AMP 404 and determines to not accept the generated OMP and maintain AMP 404. In another embodiment, the operator requests to apply different inputs to the maintenance event analysis component 412 to compare the various outputs. Thus, the AMP 404 can be maintained, replaced by the generated OMP, or the OMP is adjusted based on input from the operator.

With reference now to FIG. 8, a graph 800 illustrating the repackaging of the plurality of maintenance tasks under the AMP 404 is provided. As shown in graph 800, the AMP 404 includes the maintenance packages 610, 612, 614, and 616. As shown in FIG. 8, the maintenance package 610 includes maintenance tasks 1-5, the maintenance package 612 includes the maintenance tasks 6-8, the maintenance package 614 includes the maintenance tasks 9 and 10, and the maintenance package 616 includes the maintenance tasks 11 and 12. However, to reduce costs and/or satisfy one or more of the maintenance optimization objectives for the OMP, the maintenance event analysis component 412 repackages the maintenance tasks (e.g., maintenance tasks 1-12) within the maintenance packages 610-616 for the OMP. That is, maintenance tasks 2, 3, 4, 5, and 8 are repackaged into OMP package 802, maintenance tasks 6, 7, 9, and 10 are repackaged into OMP package 804, and maintenance tasks 11 and 12 are repackaged into OMP package 806. Further, at 808, an illustration is provided, wherein the OMP package 802 and the OMP package 804 are itemized to list the maintenance tasks that are included in each of the OMP package 802 and the OMP package 804. Further, by accessing the costs determined for each maintenance task determined at 508 in FIG. 5, a cost for each of the OMP package 802 and the OMP package 804 can be determined by adding the estimated cost of each of the maintenance tasks within each of OMP package 802 and the OMP package 804. Further, in one embodiment, the OMP package 802 and the OMP package 804 together form an OMP event (e.g., OMP event 810). Thus, to determine a cost estimate of the OMP event 810, the estimated cost of the OMP package 802 is added to the estimated cost of the OMP package 804.

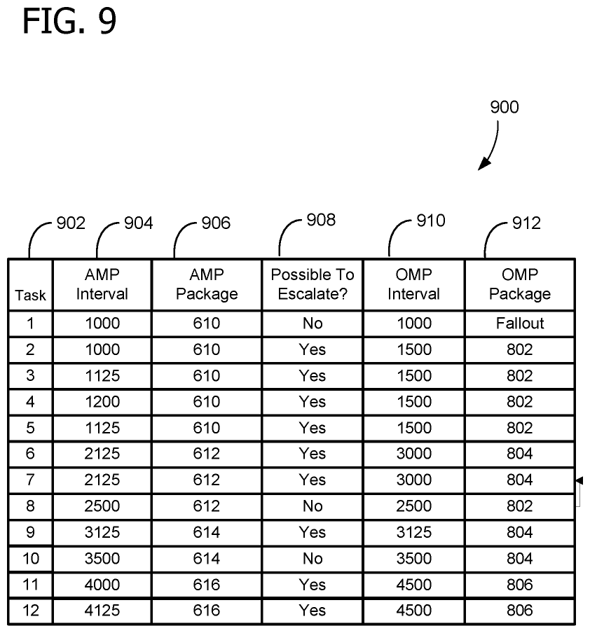

In addition, an OMP is provided in which each of the optimized maintenance packages are assigned to a particular event, with each event indicating a time/interval the optimized maintenance packages assigned thereto are scheduled to be executed. For example, with reference now to FIG. 9, a table 900 is provided, which is an illustrative example of the maintenance event analysis component 412 optimizing events for particular maintenance tasks. As shown in FIG. 9, column 902 provides a list of maintenance tasks, and each task in the column 902 has a corresponding event indicating the number of days between an inspection for the task needs to be performed, which is shown in column 904. For example, Task 1 in the column 902 is performed at an interval of every 1000 days as shown in the column 904, and Task 3 in the column 902 is performed at an interval of 1125 days as shown in the column 904.

Column 906 in FIG. 9 provides a list of the maintenance packages 610-616 in column 906. By packaging maintenance tasks, downtime, operational availability, total maintenance hours, etc. can be optimized while still meeting recommended intervals listed in the column 904 specified for each maintenance task as listed in the column 902. In some embodiments, since a maintenance task must be performed at or before its recommended event but not later, it is possible to bring maintenance tasks that must be performed later into an earlier maintenance package. In other embodiments, a maintenance task is performed at or later than its recommended, thus it is possible to postpone the maintenance tasks that can be performed later into later maintenance package. The column 906 provides a list of the maintenance packages recommended by the AMP 404.

At column 908, the maintenance event analysis component 412 has provided an indication as to whether each of the intervals listed in the column 904 can be escalated (e.g., performed at later time). For example, as shown in FIG. 9, it is indicated in column 908 that the interval of 1000 days for Task 1 cannot be escalated, but the interval of 1000 days for Task 2 can be escalated. At column 910, the maintenance event analysis component 412 provides the number of days an event can be increased to. For example, for Task 2, the interval of 1000 days can be increased to 1500 days. By increasing an interval for a maintenance task, that particular maintenance task is performed on an apparatus or fleet of the apparatus a decreased number of times for the defined length of time an operator owns the apparatus or fleet of the apparatus (e.g., based on a lease agreement). That is, increasing an interval can be thought of as postponing maintenance on that particular maintenance task. By postponing maintenance on the particular maintenance task, the costs associated with performing the particular maintenance is also postponed. In one embodiment, postponing costs for the particular maintenance task (e.g., deferring costs from a current calendar year to the next calendar year) has a positive impact on an operator, for example, if the operator is facing budget restrictions for the current calendar year. Furthermore, with a leased apparatus, the increased interval could result in the particular maintenance being postponed beyond the apparatus's lease return date. As such, the apparatus company would not incur the cost of the particular maintenance given the apparatus would be returned prior to the particular maintenance being performed. Thus, aspects of the present disclosure minimize a frequency of planned maintenance events and improves apparatus dispatch with optimized scheduling of preventative planned maintenance tasks while minimizing an occurrence of un-planned in-service maintenance tasks. Aspects of the present disclosure also enable an operator of the apparatus or fleet of the apparatus to adjusts information, such the one or more maintenance optimization objectives, the available resources, and the total operational life cycle of the apparatus (e.g., the lease end date). By adjusting the information, the operator has the ability to identify the impact of each adjustment and thus further optimize the OMP accordingly.

At column 912 in FIG. 9, each maintenance task is assigned to an OMP package based on the interval listed in the column 910. For example, Tasks 2-5 and 8 are repackaged into the OMP package 802, Tasks 6, 7, 9, and 10 are repackaged into the OMP package 804, Tasks 11 and 12 are repackaged into the OMP package 806, and Task 1 is not within the OMP package 802 and therefore must be performed outside of the OMP package 802, as indicated in column 912 as “Fallout”. As shown in the column 912, by increasing the intervals, the maintenance package 4C is no longer needed for the listed maintenance tasks. Overall, nine maintenance tasks have intervals that are increased, which will result in major savings for the operator of the apparatuses as the maintenance tasks are performed fewer times given the increase in time between the maintenance tasks (e.g., increased intervals). Thus, aspects of the present disclosure minimize a frequency of planned maintenance events and improves apparatus dispatch with optimized scheduling of preventative planned maintenance tasks while minimizing an occurrence of un-planned in-service maintenance tasks.

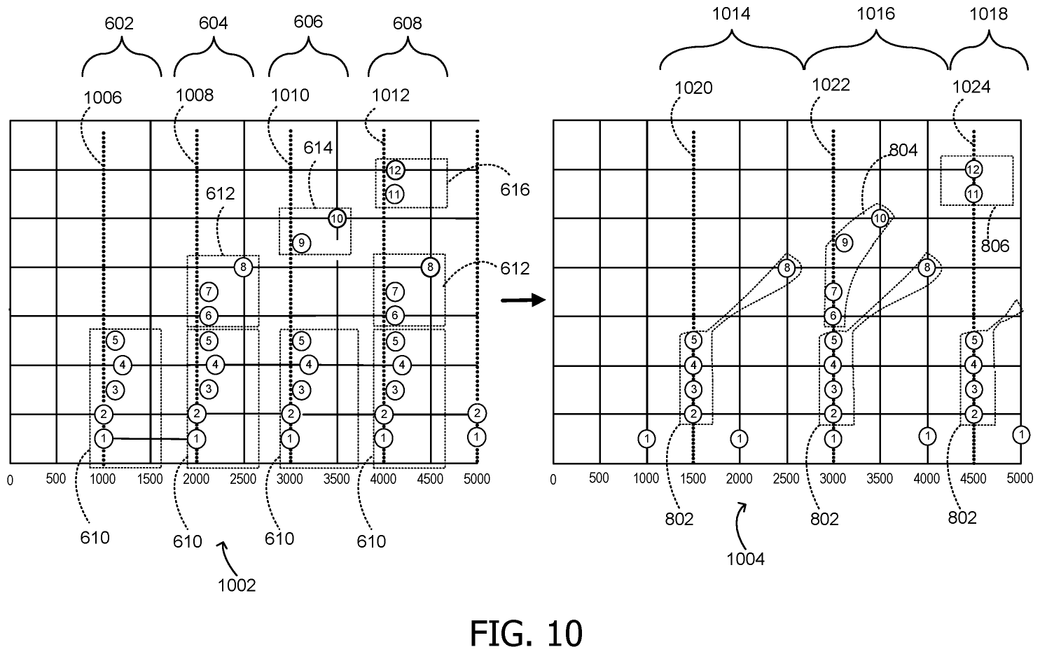

Following the example shown in FIG. 9, FIG. 10 provides an AMP graph 1002 that illustrates maintenance events 602, 604, 606, and 608 that are performed at an interval of every 1000 days, at 1006, 1008, 1010, and 1012, respectively prior to optimization by the maintenance event analysis component 412. The maintenance event 602 includes maintenance package 610, which includes maintenance tasks 1-5. The maintenance event 604 includes maintenance packages 610 and 612, which include maintenance tasks 1-8. The maintenance event 606 includes maintenance packages 610 and 614, which include maintenance tasks 1-5, 9, and 10. The maintenance event 608 includes maintenance packages 610, 612, and 616, which include maintenance tasks 1-8, 11, and 12.

FIG. 10 also provides an OMP graph 1004 that illustrates OMP events 1014, 1016, and 1018 that are performed at an interval of 1000, at 1020, 1022, and 1024, respectively after the optimization of the AMP (e.g., the AMP graph 1002). The OMP event 1014 includes the OMP package 802, which includes maintenance tasks 2-5. The OMP event 1016 includes the OMP packages 802 and 804, which include maintenance tasks 2-10. The OMP event 1018 includes the OMP packages 802 and 806, which include maintenance tasks 2-5, 11, and 12.

As shown in FIG. 9, Tasks 2, 3, 4, 5, 6, 7, 9, 11, 12 had intervals that were extended to 1500 after escalation. As a result, the OMP graph 1004 in FIG. 10 illustrates the OMP events 1014, 1016, and 1018 being performed at an interval of 1500 as indicated by 1020, 1022, and 1024. As shown in the OMP graph 1004, the number of maintenance events decreased from 5 maintenance events in the AMP graph 1002 to 3 OMP events in the OMP graph 1004. Thus, as shown in the AMP graph 1002 and the OMP graph 1004, the number of times an apparatus is offline due to maintenance events has decreased from 5 times to 3 times over the course of 5000 days which will result in major savings for the apparatus company that owns/operates the apparatuses. However, in an embodiment where the total operational life cycle of the apparatus (e.g., the defined length of time an operator owns the apparatus) was extended from 5000 days to 9000 days, optimization would result in 6 maintenance events instead of 9 maintenance events. This leads to saving of 3 maintenance events (e.g., a reduction in setup cost by 30%).

However, before the OMP is generated, a determination is made as to which maintenance event in the AMP 404 is the last event to be executed under the AMP 404, and which OMP event in the OMP is the bridging event (i.e., the first event to be executed under the OMP) in order to seamlessly transition from the AMP 404 to the OMP. The maintenance event analysis component 412 uses the accessed one or more maintenance optimization objectives, the defined length of time for the total operational life cycle of the apparatus from the AMP 404, and the estimated costs for the OMP packages to determine an OMP bridging event. For example, the OMP bridging event is determined for bridging the AMP 404 to the OMP by performing optimization using Equation 1 as the objective function, subject to: Maintenance Packages, Maintenance Events, and Access Requirement (to accomplish a maintenance task), where w1 and w2 are the weights of cost items and w3 is the weight of availability benefits. These weights are provided by an operator (e.g., owner of the apparatus or fleet of the apparatus, administrator responsible for the apparatus or fleet of the apparatus, or a user operating the apparatus) for the apparatus or fleet of the apparatus and are based on business models/objectives. For example, in one embodiment, a greater weight is applied to availability (w3) if an apparatus is used very frequently, as opposed to seasonally. In one embodiment, the OMP bridging event is not the first OMP event. Rather, the results of the statistical analysis provide that an event after the first OMP event is the OMP bridging event. Thus, upon determining the OMP bridging event, the AMP 404 seamlessly transitions from the last AMP event to the OMP bridging event, and in the example above where the first OMP event is not the OMP bridging event, the first OMP event is skipped the process continues straight to the OMP bridging event.

Minimize: (w1*Labor Cost+w2*Access Cost)−w3*Availability Equation 1:

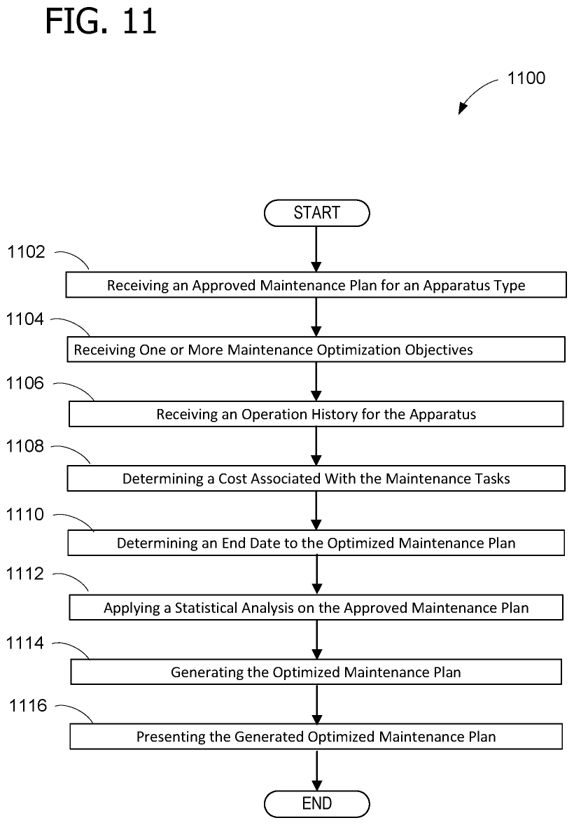

With reference now to FIG. 11, a flow chart 1100 illustrating an exemplary operation generating the OMP is provided. In one embodiment, the operations illustrated in FIG. 11 are performed by the maintenance event analysis component 412 providing instructions to the one or more processors 304. At 1102, an AMP (e.g., the AMP 404) for an apparatus type or fleet of the apparatus type is received. The AMP defines maintenance tasks for the apparatus type and defines events at which the maintenance tasks are to be performed. In one embodiment, the AMP is based on MPD, which includes information about routine planned maintenance tasks, their interval, and required access. The MPD the source document as starting point to a maintenance plan for the company that owns/operates the apparatuses. For example, when the operator is an airline, the AMP is an Airline's Approved Maintenance Plan, which includes an operators routine planned maintenance tasks which are required to comply with the obligations to ensure continuing airworthiness. The AMP be changed with appropriate approval from authorities, to align with improvements in the MPD, or new maintenance plan optimized based on airline's operation and maintenance data (e.g., OMP), which includes an optimized event of planned maintained tasks with individual data (e.g., airline data), with appropriate approval from authorities. OEM's periodically update MPD based on new information and data. MPD and MPD updates are optimized with maintenance data for a global fleet.

At 1102, one or more maintenance optimization objectives of an operator (e.g., owner of the apparatus or fleet of the apparatus, administrator responsible for the apparatus or fleet of the apparatus, or a user operating the apparatus) of an apparatus is received. Maintenance optimization objectives, functions and performance indicators are key inputs for optimizing the maintenance plan. Depending on the operator's business model, the operator has different objective functions for optimizing maintenance operations, including labor hours, maintenance task yield, and access requirement. In one embodiment, the operator is interested in different Key Performance Indicators (KPIs) including maintenance and financial performance indicators with varying levels of details. For example, in one embodiment, a particular apparatus company places more importance on apparatus or fleet of the apparatus availability resulting in fewer, but more expensive, maintenance events. In another example, a particular company places more importance on costs savings resulting in an increased number of maintenance events, but at a lower cost.

At 1106, an operation history for the apparatus or fleet of apparatus is received. That is, to provide a more accurate and impactful OMP that is designed for a particular apparatus or fleet of apparatus, specific information such as operational cycles, time in operation, miles traveled (such as flight hours for an aircraft), is applied to the generation of the OMP.

At 1108, a cost associated with the maintenance tasks is estimated. An operator, such an airline, often observe a total cost of each package, but cannot break it down by individual maintenance tasks given they are not aware of the cost of individual maintenance tasks. Using statistical analysis, the observed cost of historical events are broken down into its elements to estimate the cost of future OMP packages and events. An estimate of the cost of each OMP package and individual maintenance tasks can be determined given a total cost observed by the company that owns/operates the apparatus or fleet of the apparatus.

With reference back to FIG. 11, at 1110, an end date of the OMP is provided, which is based in part on a defined length of time to analyze the OMP, and this defined length of time is provided by an operator. For example, in one embodiment, an apparatus is purchased or leased. Thus, with a leased apparatus, the end date with the OMP is the date the lease ends in one example. In another example, the end date extends to beyond the lease end date. In addition to an apparatus's lease return date, a clearance period, and lease terms (e.g., what maintenance event must be performed before returning the apparatus to the lessor) can be collected/received to further customize the OMP. For a purchased apparatus, an “end date” or the date the operator is based on how long the apparatus will be in operation for the particular operator (e.g., until the operator, such as an owner or airline sells or retires the apparatus). Thus, in one embodiment, the “end date” for a purchased apparatus is selected by the operator as a desired date for retiring or returning the apparatus. In addition to an end date, the date the apparatus was delivered to the operator is also used as input.

At 1112, a statistical analysis is applied on the AMP, the one or more maintenance optimization objectives, the operation history of the apparatus or fleet of the apparatus, the defined length of time for a total operational life cycle of the apparatus or fleet of apparatus, and the costs associated with the OMP packages. The OMP bridging event is determined for bridging the AMP to the OMP by performing optimization using objective function as expressed in Equation 1, subject to: Maintenance Packages, Maintenance Events, and Access Requirement (to accomplish a maintenance task), where w1 and w2 are the weights of cost items and w3 is the weight of availability benefits. These weights are provided by an operator of the apparatus or fleet of the apparatus (e.g., an airline) and are based on business models/objectives. For example, in one embodiment, a greater weight is applied to availability (w3) if an apparatus is used very frequently, as opposed to seasonally. In one embodiment, the OMP bridging event is not the first OMP event. Rather, the results of the statistical analysis provide that an event after the first OMP event is the OMP bridging event. Thus, upon determining the OMP bridging event, the AMP seamlessly transitions from the last AMP event to the OMP bridging event, and in the example above where the first OMP event is not the OMP bridging event, the first OMP event is skipped and the process continues straight to the OMP bridging event.

At 1114, based on a result of the statistical analysis, the OMP is generated. The generated OMP includes an adjusted one of the defined intervals the OMP bridging event in the generated OMP is performed.

At 1116, the generated OMP is optionally presented. The generated OMP provides a particular date the optimized maintenance event is scheduled, as well dates for one or more additional maintenance events. As such, the operator of the apparatus or fleet of apparatus is provided with a seamless transition from the AMP to the OMP. In one embodiment, the generated OMP is automatically applied by replacing the AMP, and enabling a seamless transition between the AMP and the OMP without user intervention. Whether the generated OMP is presented to the operator or automatically implemented, in one embodiment, the operator compares the generated OMP with the AMP and determine to not accept the generated OMP or request to apply different inputs to the maintenance event analysis component 412 to compare the various outputs. Thus, the AMP can be maintained, replaced by the generated OMP, or the OMP is adjusted based on input from the operator.

In one embodiment, the generated OMP takes into consideration certain limitations/constraints the operator has with respect to performing maintenance on an apparatus. For example, the operator provides the number of workers that are available at any given time to perform maintenance tasks. In one embodiment, the operator also provides the number of hangars that are available to perform certain the maintenance tasks for the apparatus. As such, these limitations/constraints are used as thresholds when generating the OMP (e.g., the optimization plan only uses the number of workers and hangars available to the operator). In another embodiment, the generated OMP provides recommendations on how to further optimize the generated OMP based on the limitations/constraints provided by the operator. For example, the recommendations include a plan for hiring additional workers or building/acquiring additional hangars. These recommendations take into consideration a time it takes for hiring the workers and acquiring the hangars. As such, the recommendations provide an ability to the operator to execute the generated OMP, while also providing a plan/schedule to hire additional workers and acquire more hangars to further optimize the generated OMP.

In another embodiment, when a plurality of maintenance objectives are provided at 1104, multiple OMPs are generated at 1114. In this example, when an operator is presented with the multiple generated OMPs (e.g., at 1116), the operator is able to evaluate which of the multiple generated OMPs to follow by comparing each of the multiple generated OMPs side by side. In addition, the operator is able to see how different maintenance objectives alter an OMP, enabling the operator to determine the objectives that provide a best optimization maintenance plan for the operator.

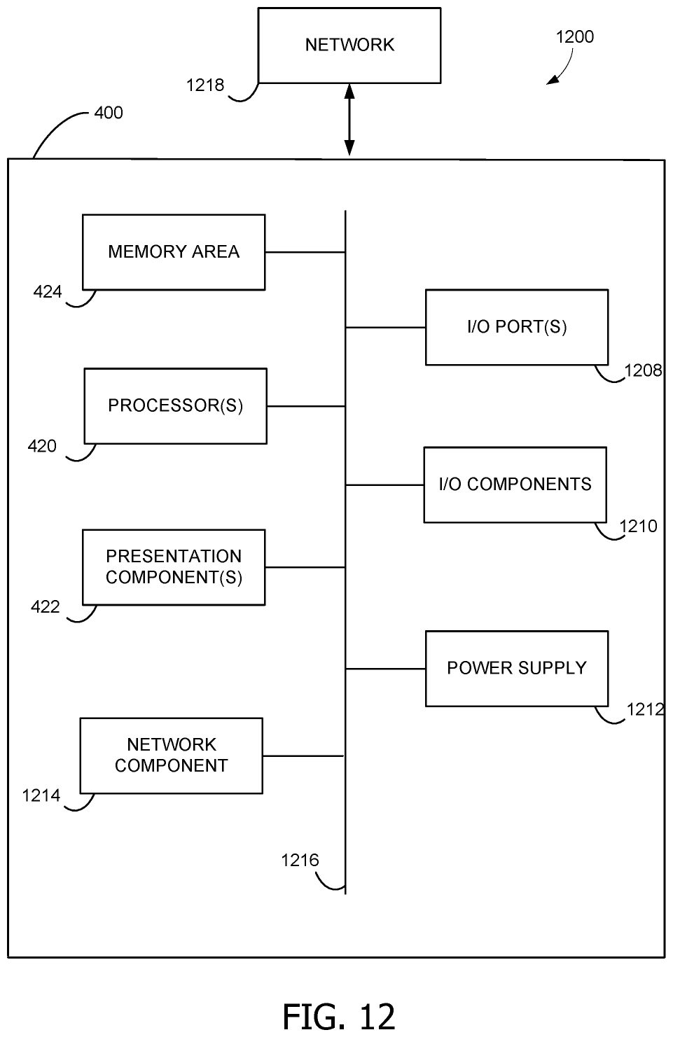

FIG. 12 is a block diagram a system 1200 for generating an OMP. The system 1200 is one example of a suitable computing environment and is not intended to suggest any limitation as to the scope of use or functionality of the invention. Neither should the system 1200 be interpreted as having any dependency or requirement relating to any one or combination of components/modules illustrated.

The examples and embodiments disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples are practiced in a variety of system configurations, including personal computers, laptops, smart phones, mobile tablets, hand-held devices, consumer electronics, specialty computing devices, etc. The disclosed examples are also practiced in distributed computing environments, where tasks are performed by remote-processing devices that are linked through a communications network. For example, a distributed computing environment hosts cloud synthetics services. Some embodiments of synthetics services provide synthetic 3D environments as well as rendering a surface in a synthetic scene.

The system 1200 includes a computing device (e.g., the computing device 400) communicatively coupled to a network 1218. The computing device 400 includes a bus 1216 that directly or indirectly couples the following devices: the memory area 424, the one or more processors 420, the one or more presentation components 422, input/output (I/O) ports 1208, I/O components 1210, a power supply 1212, and a network component 1214. The system 1200 should not be interpreted as having any dependency or requirement related to any single component or combination of components illustrated therein. While the system 1200 is depicted as a seemingly single device, in one embodiment, multiple computing devices work together and share the depicted device resources. For instance, in one embodiment, the memory area 424 is distributed across multiple devices, the processor(s) 420 provided are housed on different devices, and so on.

The bus 1216 represents one or more busses (such as an address bus, data bus, or a combination thereof). Although the various blocks of FIG. 12 are shown with lines for the sake of clarity, in reality, delineating various components is not so clear, and metaphorically, the lines would more accurately be grey and fuzzy. For example, one considers a presentation component such as a display device to be an I/O component. Also, processors have memory. Such is the nature of the art, and the diagram of FIG. 12 is merely illustrative of a system or computing device that can be used in connection with one or more embodiments of the present disclosure. Distinction is not made between such categories as “workstation,” “server,” “laptop,” “hand-held device,” etc., as all are contemplated within the scope of FIG. 12 and the references herein to a “computing device.”

In one embodiment, the memory area 424 includes any of the computer-readable media discussed herein. In one embodiment, the memory area 424 is used to store and access instructions configured to carry out the various operations disclosed herein. In some examples, the memory area 424 includes computer storage media in the form of volatile and/or nonvolatile memory, removable or non-removable memory, data disks in virtual environments, or a combination thereof.

In one embodiment, the processor(s) 420 includes any quantity of processing units that read data from various entities, such as the memory area 424 or the I/O components 1210. Specifically, the processor(s) 420 are programmed to execute computer-executable instructions for implementing aspects of the disclosure. In one embodiment, the instructions are performed by the processor, by multiple processors within the computing device 400, or by a processor external to the computing device 400. In some examples, the processor(s) 420 are programmed to execute instructions such as those illustrated in the flowcharts discussed below and depicted in the accompanying drawings. Moreover, in some examples, the processor(s) 420 represent an implementation of analog techniques to perform the operations described herein. For example, the operations are performed by an analog client computing device and/or a digital client computing device.

The presentation component(s) 422 present data indications to an operator (e.g., owner of the apparatus or fleet of the apparatus, administrator responsible for the apparatus or fleet of the apparatus, or a user operating the apparatus) or to another device. Exemplary presentation components include a display device, speaker, printing component, vibrating component, etc. One skilled in the art will understand and appreciate that computer data is presented in a number of ways, such as visually in a graphical user interface (GUI), audibly through speakers, wirelessly between the computing device 400, across a wired connection, or in other ways.

The ports 1208 allow the computing device 400 to be logically coupled to other devices including the I/O components 1210, some of which is built in. Examples of the I/O components 1210 include, for example but without limitation, a microphone, keyboard, mouse, joystick, game pad, satellite dish, scanner, printer, wireless device, etc.

In some examples, the network component 1214 includes a network interface card and/or computer-executable instructions (e.g., a driver) for operating the network interface card. In one embodiment, communication between the computing device 400 and other devices occur using any protocol or mechanism over any wired or wireless connection. In some examples, the network component 1214 is operable to communicate data over public, private, or hybrid (public and private) using a transfer protocol, between devices wirelessly using short range communication technologies (e.g., near-field communication (NFC), BLUETOOTH® branded communications, or the like), or a combination thereof.

Although described in connection with the computing device 400, examples of the disclosure are capable of implementation with numerous other general-purpose or special-purpose computing system environments, configurations, or devices. Examples of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

In one embodiment, examples of the disclosure are described in the general context of computer-executable instructions, such as program modules, executed by one or more computers or other devices in software, firmware, hardware, or a combination thereof. In one embodiment, the computer-executable instructions are organized into one or more computer-executable components or modules. Generally, program modules include, but are not limited to, routines, programs, objects, components, and data structures that perform particular tasks or implement particular abstract data types. In one embodiment, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The following paragraphs describe further aspects of the disclosure:

A1. A method for generating an optimized maintenance plan, the method comprising:

receiving an approved maintenance plan for an apparatus type, the approved maintenance plan defining maintenance tasks for the apparatus type and defining one or more intervals at which the maintenance tasks are to be performed;

receiving one or more maintenance optimization objectives of an operator of an apparatus of the apparatus type;

receiving an operation history for the apparatus;

determining a cost associated with the maintenance tasks;

determining an end date to the optimized maintenance plan;

applying a statistical analysis on the approved maintenance plan, the one or more maintenance optimization objectives, the operation history of the apparatus, the end date, and the cost associated with the maintenance tasks; and

based on a result of the statistical analysis, generating the optimized maintenance plan, the generated optimized maintenance plan comprising an adjusted one of the defined one or more intervals.

A2. The method of A1, further comprising presenting the generated optimized maintenance plan.

A3. The method of A1, automatically updating the maintenance tasks and intervals in which the maintenance tasks are to be performed based on the optimized maintenance plan.

A4. The method of A1, wherein the one or more maintenance optimization objectives comprises one or more of the following: reducing maintenance costs and reducing non-operation downtime of the apparatus.

A5. The method of A1, wherein the cost associated with the maintenance tasks is based at least on historical maintenance information of a plurality of apparatus of the apparatus type.

A6. The method of A1, wherein the apparatus type is an airplane, and wherein the operation history comprises flight cycles, and flights hours performed in association with each component or systems of components having associated component maintenance data.

A7. The method of A1, wherein the maintenance plan defines a plurality of maintenance packages comprising the maintenance tasks, a set of maintenance tasks within a maintenance package being performed at the defined one or more intervals, and wherein generating the optimized maintenance plan comprises: repackaging the maintenance tasks such that there is at least one of the following, fewer maintenance packages than in the approved maintenance plan and fewer of the maintenance tasks than in the approved maintenance plan.

A8. The method of A1, further comprising:

receiving an updated end date to the optimized maintenance plan; and based on the updated end date:

apply the statistical analysis on the approved maintenance plan, the one or more maintenance optimization objectives, the operation history of the apparatus, the updated end date, and the cost associated with the maintenance tasks; and

based on a result of the statistical analysis, generating an updated optimized maintenance plan.

A9. The method of A1, wherein the approved maintenance plan comprises a set of resources available to the operator for executing the approved maintenance plan, and wherein the method further comprises:

receiving an updated set of resources for the optimized maintenance plan; and based on the updated set of resources:
apply the statistical analysis on the approved maintenance plan, the updated set of resources, the one or more maintenance optimization objectives, the operation history of the apparatus, the end date, and the cost associated with the maintenance tasks; and
based on a result of the statistical analysis, generating an updated optimized maintenance plan.

A10. The method of A1, further comprising:

receiving an update to the one or more maintenance optimization objectives; and

based on the update to the one or more maintenance optimization objectives:

apply the statistical analysis on the approved maintenance plan, the updated one or more maintenance optimization objectives, the operation history of the apparatus, the end date, and the cost associated with the maintenance tasks; and

based on a result of the statistical analysis, generating an updated optimized maintenance plan.

A11. A system for generating an optimized maintenance plan, the system comprising:

one or more processors; and

a memory area storing a maintenance event analysis component, that when executed by the one or more processors, cause the one or more processors to perform operations comprising:
receiving an approved maintenance plan for an apparatus type, the approved maintenance plan defining maintenance tasks for the apparatus type and defining one or more intervals at which the maintenance tasks are to be performed;
receiving one or more maintenance optimization objectives of an operator of an apparatus of the apparatus type;
receiving an operation history for the apparatus;
determining a cost associated with the maintenance tasks;
determining an end date to the optimized maintenance plan;
applying a statistical analysis on the approved maintenance plan, the one or more maintenance optimization objectives, the operation history of the apparatus, the end date, and the cost associated with the maintenance tasks; and
based on a result of the statistical analysis, generating the optimized maintenance plan, the generated optimized maintenance plan comprising an adjusted one of the defined one or more intervals.

A12. The system of A11, wherein the operations further comprise presenting the generated optimized maintenance plan.

A13. The system of A11, wherein the operations further comprise automatically updating the maintenance tasks and intervals in which the maintenance tasks are to be performed based on the optimized maintenance plan.

A14. The system of A11, wherein the one or more maintenance optimization objectives comprises one or more of the following: reducing maintenance costs and reducing non-operation downtime of the apparatus.

A15. The system of A11, wherein the cost associated with the maintenance tasks is based at least on historical maintenance information of a plurality of apparatus of the apparatus type.

A16. The system of A11, wherein the apparatus type is an airplane, and wherein the operation history comprises flight cycles, and flights hours performed in association with each component or systems of components having associated component maintenance data

A17. The system of A11, wherein the maintenance plan defines a plurality of maintenance packages comprising the maintenance tasks, a set of maintenance tasks within a maintenance package being performed at the defined one or more intervals, and wherein generating the optimized maintenance plan comprises: repackaging the maintenance tasks such that there is at least one of the following, fewer maintenance packages than in the approved maintenance plan and fewer of the maintenance tasks than in the approved maintenance plan.

A18. The system of A11, wherein the operations further comprise:

receiving an updated end date to the optimized maintenance plan; and based on the updated end date:

apply the statistical analysis on the approved maintenance plan, the one or more maintenance optimization objectives, the operation history of the apparatus, the updated end date, and the cost associated with the maintenance tasks; and

based on a result of the statistical analysis, generating an updated optimized maintenance plan.

A19. The system of A11, wherein the approved maintenance plan comprises a set of resources available to the operator for executing the approved maintenance plan, and wherein the operations further comprise:

receiving an updated set of resources for the optimized maintenance plan; and based on the updated set of resources:
apply the statistical analysis on the approved maintenance plan, the updated set of resources, the one or more maintenance optimization objectives, the operation history of the apparatus, the end date, and the cost associated with the maintenance tasks; and
based on a result of the statistical analysis, generating an updated optimized maintenance plan.

A20. The system of A11, wherein the operations further comprise:

receiving an update to the one or more maintenance optimization objectives; and

based on the update to the one or more maintenance optimization objectives:

apply the statistical analysis on the approved maintenance plan, the updated one or more maintenance optimization objectives, the operation history of the apparatus, the end date, and the cost associated with the maintenance tasks; and

based on a result of the statistical analysis, generating an updated optimized maintenance plan.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for generating an optimized maintenance plan, the method comprising:
receiving an approved maintenance plan for an apparatus type, the approved maintenance plan defining maintenance tasks for the apparatus type and defining one or more intervals at which the maintenance tasks are to be performed;
receiving one or more maintenance optimization objectives of an operator of an apparatus of the apparatus type;
receiving an operation history for the apparatus;
determining a cost associated with the maintenance tasks;
determining an end date to the optimized maintenance plan;
applying a statistical analysis on the approved maintenance plan, the one or more maintenance optimization objectives, the operation history of the apparatus, the end date, and the cost associated with the maintenance tasks; and
based on a result of the statistical analysis, generating the optimized maintenance plan, the generated optimized maintenance plan comprising an adjusted one of the defined one or more intervals.

2. The method of claim 1, further comprising presenting the generated optimized maintenance plan.

3. The method of claim 1, automatically updating the maintenance tasks and intervals in which the maintenance tasks are to be performed based on the optimized maintenance plan.

4. The method of claim 1, wherein the one or more maintenance optimization objectives comprises one or more of the following: reducing maintenance costs and reducing non-operation downtime of the apparatus.

5. The method of claim 1, wherein the cost associated with the maintenance tasks is based at least on historical maintenance information of a plurality of apparatus of the apparatus type.

6. The method of claim 1, wherein the apparatus type is an airplane, and wherein the operation history comprises flight cycles, and flights hours performed in association with each component or systems of components having associated component maintenance data.

7. The method of claim 1, wherein the maintenance plan defines a plurality of maintenance packages comprising the maintenance tasks, a set of maintenance tasks within a maintenance package being performed at the defined one or more intervals, and wherein generating the optimized maintenance plan comprises: repackaging the maintenance tasks such that there is at least one of the following, fewer maintenance packages than in the approved maintenance plan and fewer of the maintenance tasks than in the approved maintenance plan.

8. The method of claim 1, further comprising:
receiving an updated end date to the optimized maintenance plan; and based on the updated end date:
apply the statistical analysis on the approved maintenance plan, the one or more maintenance optimization objectives, the operation history of the apparatus, the updated end date, and the cost associated with the maintenance tasks; and
based on a result of the statistical analysis, generating an updated optimized maintenance plan.

9. The method of claim 1, wherein the approved maintenance plan comprises a set of resources available to the operator for executing the approved maintenance plan, and wherein the method further comprises:
receiving an updated set of resources for the optimized maintenance plan; and based on the updated set of resources:
apply the statistical analysis on the approved maintenance plan, the updated set of resources, the one or more maintenance optimization objectives, the operation history of the apparatus, the end date, and the cost associated with the maintenance tasks; and
based on a result of the statistical analysis, generating an updated optimized maintenance plan.

10. The method of claim 1, further comprising:
receiving an update to the one or more maintenance optimization objectives; and
based on the update to the one or more maintenance optimization objectives:
apply the statistical analysis on the approved maintenance plan, the updated one or more maintenance optimization objectives, the operation history of the apparatus, the end date, and the cost associated with the maintenance tasks; and
based on a result of the statistical analysis, generating an updated optimized maintenance plan.

11. A system for generating an optimized maintenance plan, the system comprising:
one or more processors; and
a memory area storing a maintenance event analysis component, that when executed by the one or more processors, cause the one or more processors to perform operations comprising:
receiving an approved maintenance plan for an apparatus type, the approved maintenance plan defining maintenance tasks for the apparatus type and defining one or more intervals at which the maintenance tasks are to be performed;
receiving one or more maintenance optimization objectives of an operator of an apparatus of the apparatus type;
receiving an operation history for the apparatus;
determining a cost associated with the maintenance tasks;
determining an end date to the optimized maintenance plan;
applying a statistical analysis on the approved maintenance plan, the one or more maintenance optimization objectives, the operation history of the apparatus, the end date, and the cost associated with the maintenance tasks; and
based on a result of the statistical analysis, generating the optimized maintenance plan, the generated optimized maintenance plan comprising an adjusted one of the defined one or more intervals.

12. The system of claim 11, wherein the operations further comprise presenting the generated optimized maintenance plan.

13. The system of claim 11, wherein the operations further comprise automatically updating the maintenance tasks and intervals in which the maintenance tasks are to be performed based on the optimized maintenance plan.

14. The system of claim 11, wherein the one or more maintenance optimization objectives comprises one or more of the following: reducing maintenance costs and reducing non-operation downtime of the apparatus.

15. The system of claim 11, wherein the cost associated with the maintenance tasks is based at least on historical maintenance information of a plurality of apparatus of the apparatus type.

16. The system of claim 11, wherein the apparatus type is an airplane, and wherein the operation history comprises flight cycles, and flights hours performed in association with each component or systems of components having associated component maintenance data

17. The system of claim 11, wherein the maintenance plan defines a plurality of maintenance packages comprising the maintenance tasks, a set of maintenance tasks within a maintenance package being performed at the defined one or more intervals, and wherein generating the optimized maintenance plan comprises: repackaging the maintenance tasks such that there is at least one of the following, fewer maintenance packages than in the approved maintenance plan and fewer of the maintenance tasks than in the approved maintenance plan.

18. The system of claim 11, wherein the operations further comprise:
receiving an updated end date to the optimized maintenance plan; and based on the updated end date:
apply the statistical analysis on the approved maintenance plan, the one or more maintenance optimization objectives, the operation history of the apparatus, the updated end date, and the cost associated with the maintenance tasks; and
based on a result of the statistical analysis, generating an updated optimized maintenance plan.

19. The system of claim 11, wherein the approved maintenance plan comprises a set of resources available to the operator for executing the approved maintenance plan, and wherein the operations further comprise:
receiving an updated set of resources for the optimized maintenance plan; and based on the updated set of resources:
apply the statistical analysis on the approved maintenance plan, the updated set of resources, the one or more maintenance optimization objectives, the operation history of the apparatus, the end date, and the cost associated with the maintenance tasks; and
based on a result of the statistical analysis, generating an updated optimized maintenance plan.

20. The system of claim 11, wherein the operations further comprise:
receiving an update to the one or more maintenance optimization objectives; and
based on the update to the one or more maintenance optimization objectives:
apply the statistical analysis on the approved maintenance plan, the updated one or more maintenance optimization objectives, the operation history of the apparatus, the end date, and the cost associated with the maintenance tasks; and
based on a result of the statistical analysis, generating an updated optimized maintenance plan.
